(19) United States
(12) Patent Application Publication
(10) Pub. No.: US 2022/0138222 A1
(43) Pub. Date: May 5, 2022

(54) METHOD FOR CONTROLLING A BLOCK SIZE IN BLOCKCHAIN NETWORK AND BLOCKCHAIN NETWORK USING THE METHOD

(71) Applicant: INDUSTRY-UNIVERSITY COOPERATION FOUNDATION SOGANG UNIVERSITY, Seoul (KR)

(72) Inventors: Ju Wook JANG, Seoul (KR); Tae Rim LEE, Seoul (KR)

(21) Appl. No.: 17/510,151

(22) Filed: Oct. 25, 2021

(30) Foreign Application Priority Data
Oct. 30, 2020 (KR) 10-2020-0142877

(51) Int. Cl. G06F 16/27; G06F 16/23

(52) U.S. Cl. CPC G06F 16/27; G06F 16/23

(57) ABSTRACT

Provided is a block size adjustment method in a blockchain network including: (a) setting the block size to an initial value; (b) waiting for a transaction request, and processing a transaction to be requested; (c) if the processing of the requested transaction is successful, generating a block according to the block size, and increasing the block size to increase the number of transactions that can be processed at one time; and (d) if the processing of the requested transaction fails, reducing the block size without block generation to reduce the number of transactions that can be processed at one time. By repeatedly performing steps (b), (c) and (d) using the block size adjusted by whether or not a transaction is processed, the block size is flexibly adjusted and a block according to the adjusted block size is generated. Therefore, the throughput of the blockchain network can be significantly improved.

### TECHNICAL FIELD

The present invention relates to a block size adjustment method in a blockchain network, and more specifically, to a block size adjustment method in a Hyperledger-based blockchain network which the block size can be adjusted linearly or non-linearly according to the dependency on the transaction in order to improve the network throughput.

### BACKGROUND ART

In a blockchain network, users participating in the network directly verify the data and do consensus to distributed-store the data, and users can directly transact without the intervention of a central management authority. Since it is difficult to forge and falsify transactions, the blockchain network not only guarantees the reliability of the data, but also guarantees the transparency and integrity of the data because all users have the same blockchain ledger and can be viewed by anyone. Therefore, the blockchain technology is used as a data forgery/falsification prevention technology based on distributed computing technology, and the blockchain is a new technology pattern that creates new opportunities for innovation and growth and reduces the cost and risk of management of the related businesses by fundamentally improving the existing transaction-oriented networks such as finance and supply chains.

This blockchain network is divided into a public blockchain network and a private blockchain network. In the public blockchain network, all data is made public, and anyone can participate in the network and become a node that can verify data and generate blocks. Currently, Bitcoin and Ethereum are public blockchain networks.

On the other hand, private blockchain networks are developed for companies, and are also called private blockchains, closed blockchains, permissioned blockchains, corporate blockchains, or enterprise blockchains. The transaction list and actions are shared and can be tracked only to the permitted participants. And, in order to participate in the private blockchain network, only a participant authorized by one subject can participate and generate a block, and a representative example of a private blockchain is Hyperledger Fabric. In Hyperledger Fabric, only permitted participants can participate in the blockchain network, and it is possible to configure an organization within the network and share different ledgers using a logical channel.

In the hyper ledger-based blockchain network, unlike the conventional public blockchain network, only verified participants participate in the network as a node by configuring the network in a private environment, and the number of the nodes is small. And, it has the advantage of having a high TPS (throughput) in the consensus process for the block generation, and it has excellent efficiency and scalability, so it can be universally introduced to the industries such as corporate blockchain platforms using the private blockchain network.

In general, the number of transactions to be stored per one block is set in advance and is called block size, block batch size or batch size. Therefore, the number of transactions to be stored per one block is expressed as a block size in the specification of the present invention.

On the other hand, in a blockchain network, a transaction is a unit of work that is done at one time, and it is also possible to process multiple transactions at the same time as when processing multiple chain codes in Hyperledger. In this way, when multiple transactions are processed at the same time, the same variable being in the multiple transactions is changed at the same time, and this case is expressed as “There is a dependency on the transaction”.

However, in the process of generating a new block, when the block size of the network is large and the dependency on the transactions to be processed is high, a plurality of transactions must be processed in parallel at one time when generating one block. In this case, in the process of simultaneously changing one variable by parallel processing of a plurality of transactions, a read after write (RAW) problem, which is one of the types of data hazard of parallel processing, occurs. For example, in parallel processing of multiple transactions, if the first transaction changes the value of the variable, and the second transaction also changes the value of the variable, the first transaction must read the changed value, but the block has not yet been generated and then not recoded. Therefore, an error is made in that the value before the change is read incorrectly. As a result, there is a possibility that block generation fails. If block generation fails in this way, the overall throughput of the network is significantly reduced.

In order to solve this problem caused by the large block size as described above, the conventional method uses a method of reducing the block size itself. However, in the conventional method of reducing the block size, the number of block generation failures is decreased even if the transaction dependency increases. However, since the block size itself is small, the number of transactions that can be processed at one time is small, so that there is a problem which the throughput is still reduced as a result.

FIGS. 1A and 1B are a graph showing whether a block is generated by processing a transaction according to the dependency on a transaction when the block size is fixed according to the prior art. These are graphs for 2 cases in which FIG. 1A is a case where the block size is small and FIG. 1B is a case where the block size is large. In FIGS. 1A and 1B, the gray color indicates block generation success, the dark gray color indicates block generation failure, and the final throughput is expressed as the area of the part shown in gray color.

As shown in the FIG. 1A, when the block size is determined as small as 2 or 3 in the number of transactions, the number of block generation failures is small even if the transaction dependency increases. But, since the block size is small and the number of transactions that can be performed at one time is small, the throughput decreases. On the other hand, as shown in the FIG. 1B, when the block size is determined as large as 50 in the number of transactions, as the dependency on the transaction increases, the probability of block generation failure increases, which leads to a decrease in throughput. As described above, when the block size is fixed according to the conventional method, it can be seen that the throughput of the network is reduced. In addition, since, the block size does not change and always maintains a constant value even if the network conditions change in the conventional method, the possibility that block generation continues to fail increases because it cannot properly respond to the network changes.

### SUMMARY

In order to solve the problems described above, the object of the present invention is to provide a method of adjusting the block size of the blockchain network which block generation is determined according to the success or failure of transaction processing due to the transaction dependency, and the block size is adjusted linearly or non-linearly according to block generation to improve the throughput of the blockchain network.

A block size adjustment method in a blockchain network according to a first aspect of the present invention for achieving the above-described technical problem includes the steps of: (a) setting the block size to an initial value; (b) waiting for a transaction request, and processing a transaction to be requested; (c) if the processing of the requested transaction is successful, generating a block according to the set block size and increasing the block size in order to increase the number of transactions that can be processed at one time; and (d) if the processing of the requested transaction fails, reducing the block size without block generation in order to reduce the number of transactions that can be processed at one time. By repeatedly performing the steps (b), (c) and (d), the block size can be flexibly adjusted according to the dependency on the transaction and a new block is generated according to the adjusted block size.

In the block size adjustment method of the blockchain network according to the first aspect described above, the block size is preferably the number of transactions that can be processed and stored in one block at one time.

In the block size adjustment method of the blockchain network according to the first aspect described above, if the block generation is successful in step (c), the block size is linearly increased, and if the transaction processing fails in step (d), the block size is decreased exponentially.

In the block size adjustment method of the blockchain network according to the first aspect described above, in step (a), it is preferable that the initial value of the block size is set to the lowest value of the block size.

in a blockchain network consisting of a plurality of nodes according to the second aspect of the present invention, each node sets the block size to an initial value, waits for a transaction request, and processes a transaction to be requested. If the processing of the requested transaction is successful, the node generates a block and increases the block size in order to the number of transactions that can be processed at one time. If the processing of the requested transaction is failed, the node decreases the block size without a block generation in order to decrease the number of transactions that can be processed at one time.

In the blockchain network according to the second aspect described above, it is preferable that the initial value of the block size is set to the lowest value of the block size.

The block size adjustment method according to the present invention increases linearly the block size and a block is generated when transaction processing is successful by the transaction dependency, and reduces exponentially the block size without a block generation when transaction processing fails due to transaction dependency. By flexibly adjusting the block size, it is possible to significantly improve throughput compared to the conventional network having a fixed block size.

According to the configuration described above, the present invention provides a method for flexibly adjusting the block size in the hyperledger-based blockchain network according to whether or not a block is generated after transaction processing without terminating the network in order to solve the problem of throughput reduction in the conventional network having a fixed block size.

The conventional network with a fixed block size does not know the content of the following transactions when the next block is generated and cannot adapt flexibly when the network situation changes, even if the block size is high or small, or the block size is optimal to achieve maximum efficiency in the current situation. On the other hand, the network according to the present invention flexibly adjusts the block size according to whether or not the transaction processing is successful by transaction dependency to modify the block size according to the transaction dependency regardless of the situation of the network. Therefore, the throughput efficiency of the network according to the present invention is significantly higher than that of the conventional network having the fixed block size in a random network situation.

### BRIEF DESCRIPTION OF THE DRAWINGS

FIGS. 1A and 1B are graphs showing whether a block is generated by processing a transaction according to the dependency on the transaction when the block size is fixed according to the prior art, which FIG. 1A is a graph for a case where the block size is small, and FIG. 1B is a graph for a case where the block size is large.

FIG. 2 is a schematic diagram illustrating a linear increase and an exponential decrease in block size according to circumstances in a blockchain network to which the block size adjustment method according to a preferred embodiment of the present invention is applied.

FIG. 3 is a flowchart illustrating a block size adjustment method according to a preferred embodiment of the present invention.

FIG. 4 is a graph showing whether or not a block is generated by flexibly adjusting the block size according to the dependency on a transaction in the block size adjustment method according to the preferred embodiment of the present invention.

### DETAILED DESCRIPTION

The present invention proposes a method of flexibly adjusting the block size according to whether or not a block is generated according to the transaction processing result without terminating the network in order to solve the problem of reducing the throughput of a fixed block size in a hyperledger-based blockchain network.

The block size is defined as the number of transactions being processed per a block. In the case of a fixed block size, throughput problems occur when the block size is high or low. Even if the block size is optimized to have maximum throughputs in current situation of the network, when the next block is generated, it is not known what kind of transaction to be requested will occur, so it cannot adapt flexibly if the network situation changes.

Therefore, after setting the first block size to 1 as a lowest value when configuring the network, each time a new block is generated, the block size of the next block to be generated is linearly increased by 1. When sufficient time passes and the block size increases and the dependency on the transaction increases, the transaction to be requested cannot be processed due to problems caused by parallel processing.

As such, if the transaction to be requested cannot be processed and then block generation fails, the block size is reduced by half.

Therefore, when the block size adjustment method according to the present invention is applied to a blockchain network, the block size changes depending on the dependency on the transaction over time no matter what situation occurs in the network. Therefore, compared to that of the fixed block size in random situation for the network, it can be seen that the throughput efficiency is significantly increased.

Hereinafter, a block size adjustment method in a blockchain network according to a preferred embodiment of the present invention will be described in detail with reference to the accompanying drawings. The block size adjustment method in the blockchain network according to the present invention is executed by the microprocessor of the nodes constituting the blockchain network.

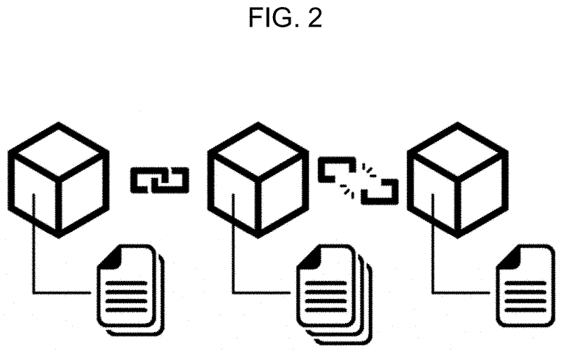

FIG. 2 is a schematic diagram illustrating a linear increase and an exponential decrease in block size according to circumstances of a blockchain network to which the block size adjustment method according to a preferred embodiment of the present invention is applied. Referring to FIG. 2, in the blockchain network according to the present invention, block generation is determined according to the dependency on a transaction, and the block size is flexibly adjusted according to whether or not a block is generated.

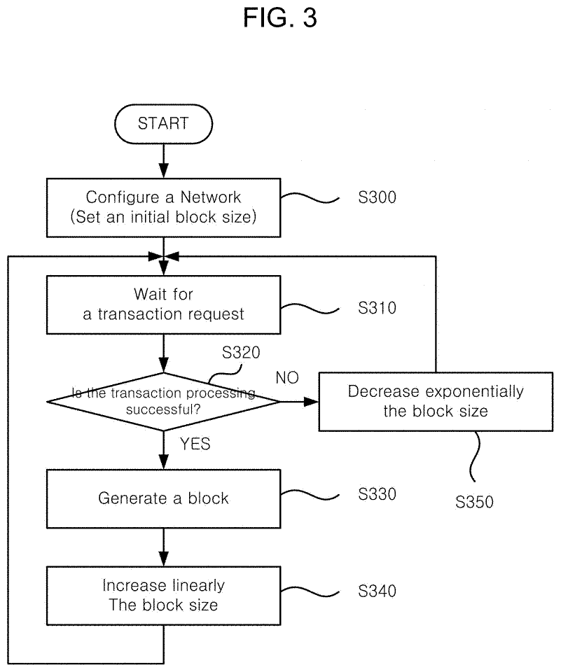

FIG. 3 is a flowchart illustrating a block size adjustment method according to a preferred embodiment of the present invention.

Referring to FIG. 3, a network is configured by first setting a block size to a preset initial value (step 300). In this case, it is preferable to set the minimum value for the initial value of the block size. Since the block size is the number of transactions per a block, it is most preferable to set the minimum value to 1. Next, while waiting for a transaction request (step 310), when a transaction request occurs, the transaction to be requested is processed according to the previously set block size (step 320) . At this time, if the transaction to be requested is successfully processed, a block is generated (step 330) and the block size value is linearly increased by a preset unit (step 340), and then the process returns to the waiting step for a transaction request (step 310). In this case, the linearly increasing unit of the block size may be 1, and the unit may be set differently depending on the performance of the system.

On the other hand, if the transaction to be requested is not successfully processed/ the block size value is decreased (step 350), and then the process returns to the transaction request waiting step (step 310). In this case, the block size may be reduced exponentially from the previously set value or reduced to half of the previous set value.

To summarize the above process, when the network according to the present invention is initially configured, the block size is set to the lowest value to operate the network, and when the block is generated after processing the transaction requests, whether or not the transaction is processed is determined according to the dependency on the transaction.

If the transaction to be requested is failed, the block size is reduced by half and the process returns to the step of waiting for a transaction request again. If all transaction requests are processed successfully and the block is successfully generated, the block size is increased by 1, and then it goes back to waiting for a transaction request. In this way, when it returns to the state of waiting for the transaction request, it goes back to the state of checking whether or not the transaction is processed, so the network operates while the block size continuously changes according to the state of the network.

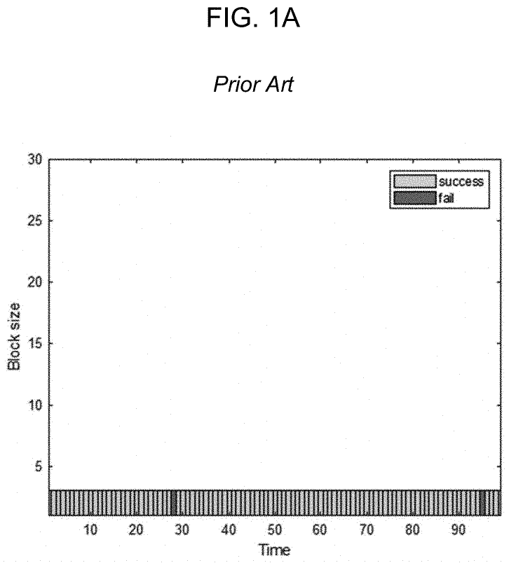

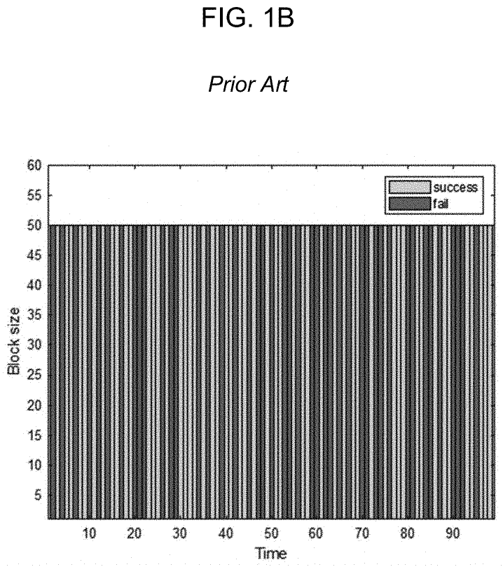

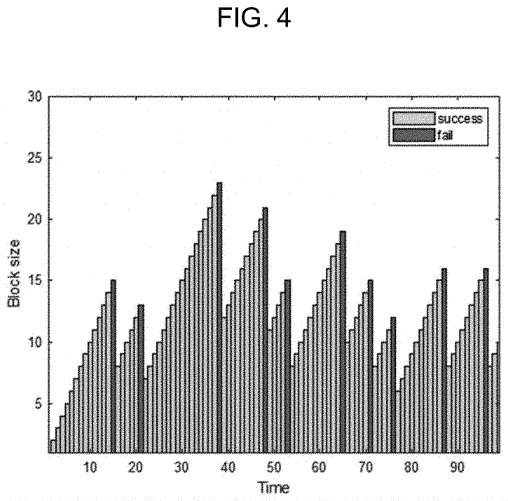

FIG. 4 is a graph showing whether or not a block is generated by flexibly adjusting the block size according to the dependency on a transaction in the block size adjustment method according to the preferred embodiment of the present invention. Referring to FIG. 4, the gray color indicates the success of block generation, the dark gray color indicates the failure of block generation, and the final throughput is represented by the area of the gray area in the graph. Since the block size of the network according to the present invention is not fixed, the block size is linearly increased or exponentially decreased depending on the success of the transaction processing and the success of block generation. As the network situation changes, the block size becomes larger or smaller. Accordingly, it can be confirmed that the block size and throughput of the network are stabilized by oscillating within a certain range through a comparison between FIG. 1 and FIG. 4, and the throughput at that time is significantly higher than that of a network having a fixed block size.

Therefore, the blockchain network to which the block size adjustment method according to the present invention is applied can solve the problem that the throughput of the network is reduced when the block generation fails because the transaction request is not processed in a situation where the transaction request is not known.

While the present invention has been particularly illustrated and described with respect to the preferred embodiments thereof, it should be understood by the skilled in the art that the invention is not limited to the disclosed embodiments, but various modifications and applications not illustrated in the above description can be made without departing from the spirit of the invention. In addition, the differences related to such modifications and applications should be construed as being included in the scope of the present invention as set forth in the appended claims.

What is claimed is:

1. Method of adjusting a block size of a blockchain network performed by a processor of a node constituting the blockchain network, comprising steps of:
(a) setting the block size to an initial value;
(b) waiting for a transaction request, and processing a transaction to be requested;
(c) if the processing of the requested transaction is successful, generating a block according to the block size, and then increasing the block size in order to increase the number of transactions that can be processed at one time; and
(d) if the processing of the requested transaction fails, reducing the block size without block generation in order to reduce the number of transactions that can be processed at one time;
wherein by repeatedly performing steps (b), (c) and (d) using the block size adjusted by whether or not a transaction is processed, the block size is flexibly adjusted and a block having the adjusted block size is generated.

2. The method according to claim 1, wherein the block size is determined by the number of transactions that can be processed and stored in one block.

3. The method of claim 1, wherein in step (c), if the transaction processing succeeds and the block is generated, the block size is linearly increased, and
in the step (d), if the transaction processing fails, the block size is reduced exponentially without block generation.

4. The method according to claim 1, wherein in step (c), if the transaction processing succeeds and a block is generated, the block size is linearly increased by 1, and
in step (d), if the transaction processing fails, the block size is reduced to half of the previous block size without generating a block.

5. The method of claim 1, wherein, in step (a), the initial value of the block size is set to a lowest value of the block size.

6. A blockchain network consisting of a plurality of nodes,
wherein each node sets a block size to an initial value, waits for a transaction request, and processes a transaction to be requested, and
if the requested transaction is processed successfully, the node generates a block and increases the block size in order to increases the number of transactions that can be processed at one time, and
if the requested transaction processing fails, the node reduces the block size without block generation in order to reduce the number of transactions that can be processed at one time.

7. The blockchain network according to claim 6, wherein the block size is determined by the number of transactions that can be processed and stored in one block.

8. The blockchain network according to claim 6, wherein each node increases the block size linearly if the processing of the requested transaction succeeds, and decreases exponentially the block size if the processing of the requested transaction fails.

9. The blockchain network according to claim 6, wherein each node increases the block size linearly by 1 if the processing of the requested transaction is successful, and
reduces the block size to half of the previous block size if the processing of the requested transaction fails.

10. The blockchain network according to claim 6, wherein the initial value of the block size is set to a lowest value of the block size.
